(19) United States
(12) Patent Application Publication
(10) Pub. No.: US 2008/0256380 A1
(43) Pub. Date: Oct. 16, 2008

(54) SEMICONDUCTOR INTEGRATED CIRCUIT AND LAYOUT METHOD FOR THE SAME

(76) Inventors: Masanori Tsutsumi, Kyoto (JP); Shoh Yoshinaga, Kyoto (JP)

Correspondence Address: MCDERMOTT WILL & EMERY LLP, 600 13TH STREET, NW, WASHINGTON, DC, 20005-3096, US

(21) Appl. No.: 12/102,347

(22) Filed: Apr. 14, 2008

(30) Foreign Application Priority Data
Apr. 16, 2007 (JP) 2007-106929
Mar. 5, 2008 (JP) 2008-054573

(51) Int. Cl. G06F 1/10

(52) U.S. Cl. 713/500

(57) ABSTRACT

A functional block is divided into a plurality of regions. In each region, a clock main line extending along a first direction, a clock branch line group including a plurality of clock branch lines extending along a second direction perpendicular to the first direction and electrically connected to the clock main line, a clock driving cell electrically connected to the clock main line and a clock synchronous cell group including a plurality of clock synchronous cells electrically connected to the clock main line or the clock branch line group are provided. The clock branch line groups of the respective regions are electrically separated from each other, and the clock driving cell singly drives the clock main line connected thereto and the clock branch line group connected to the clock main line.

### BACKGROUND OF THE INVENTION

The present invention relates to a semiconductor integrated circuit including a clock distribution circuit for distributing a clock signal in a functional block formed on a semiconductor integrated circuit by using standard cells and a layout method for the semiconductor integrated circuit.

Recently, in accordance with the increased speed and improved performance of a digital circuit, the operation speed and the degree of integration of a semiconductor integrated circuit have been more and more increased.

In accordance with the increased operation speed of a semiconductor integrated circuit, it has become significant to suppress signal delay variation of a clock signal used for attaining synchronization of flip-flops included in the semiconductor integrated circuit (which variation is designated as clock skew). The clock skew corresponds to a difference in time when a clock signal reaches between synchronous flip-flops, and large clock skew disadvantageously causes lowering of the operation frequency and the malfunction of the circuit.

Furthermore, in order to increase the degree of integration of a semiconductor integrated circuit, it is necessary to shrink the fabrication process. Therefore, the width of signal lines used in a semiconductor integrated circuit is reducing year by year, and hence, the wiring delay is increased because of increased wiring resistance.

Since the wiring delay was conventionally small, clock skew derived from variation in gate delay among cells was dominant. However, since clock skew derived from variation in the wiring delay is recently seriously increased, it is necessary to reduce the wiring delay variation of a clock signal.

As a conventional clock wiring structure for reducing the wiring delay variation of a clock signal, a clock wiring technique such as comb clock wiring, fish-bone clock wiring or mesh clock wiring is employed (see, for example, Japanese Laid-Open Patent Publication Nos. 9-283631 and 10-199985).

Also, an example of a method for reducing the wiring delay of a clock signal in a semiconductor integrated circuit is disclosed in Japanese Laid-Open Patent Publication No. 2003-332430.

In the comb clock wiring, the lowering of operation speed is prevented by controlling the wiring delay variation of clock signals for avoiding the malfunction of the circuit. However, although the wiring delay variation can be controlled when flip-flops on a signal supplying side and a signal receiving side are provided in a one-to-one relationship, the flip-flops are provided in a many-to-many relationship in a general circuit, and hence, it is difficult to control the wiring delay variation with respect to all the flip-flops.

Furthermore, the fish-bone clock wiring is effective when the chip size is small, but the length of a branch line along the horizontal direction is so large in a semiconductor integrated circuit of a large scale that the wiring resistance of the branch line from the center to the end is very large. Therefore, clock skew between the center and the peripheral portion of a chip is disadvantageously increased due to the wiring delay variation. Moreover, since a large number of clock synchronous cells are connected to a clock main line as load, the wiring delay variation in the clock main line is also disadvantageously increased.

Furthermore, in the mesh clock wiring, since clock lines are provided in the whole block in the shape of a mesh, although the wiring resistance is small and the wiring delay variation is small, the total length of the clock lines is so large that the load capacitance of a clock driving cell used for supplying a clock signal is increased. Therefore, the power consumption is disadvantageously large.

Moreover, in all of the comb clock wiring, the fish-bone clock wiring and the mesh clock wiring, a clock signal to be supplied to clock synchronous cells of the whole block is driven by one clock line, and hence, the load capacitance is very large. Therefore, it is necessary to simultaneously drive the whole clock line by a plurality of clock driving cells. In such a case, if there is clock skew up to the plural clock driving cells, a through current flows between the clock driving cells through the fish-bone clock wiring portion or the mesh clock wiring portion, which increases the power consumption.

Additionally, in the case where one signal line is thus driven by a plurality of clock driving cells, the delay cannot be precisely calculated and the influence of crosstalk with another signal line cannot be considered by using a currently commercially available delay calculation tool of a standard cell level.

Furthermore, when an upper layer interconnection with a large thickness and low resistance is to be used for reducing the wiring delay of a clock signal, it is necessary to use an interconnection with a large width due to restriction of the fabrication process. Alternatively, since contacts to be used for interlayer connection to the upper layer interconnection are so large that a shortage of routing resources occur when the upper layer interconnection is entirely used as the clock wiring. Therefore, it is difficult to use the upper layer interconnection in a portion close to an end of a clock tree in which a large number of clock driving cells or clock synchronous cells are driven.

### SUMMARY OF THE INVENTION

The present invention was devised in consideration of the aforementioned conventional disadvantages, and an object of the invention is providing a clock distribution circuit in which the power consumption is small, the clock skew is small and the load capacitance of a clock driving cell used for supplying a clock signal is small even when used in a semiconductor integrated circuit of a large scale.

In order to achieve the object, according to a preferred aspect of the invention, the semiconductor integrated circuit includes a clock distribution circuit for distributing a clock signal in a functional block constructed by using standard cells, and the clock distribution circuit includes a first clock main line extending along a first direction; a first clock branch line group including a plurality of clock branch lines extending along a second direction perpendicular to the first direction and electrically connected to the first clock main line; a first clock driving cell electrically connected to the first clock main line; a first clock synchronous cell group including a plurality of clock synchronous cells electrically connected to the first clock main line or the first clock branch line group; a second clock main line extending in parallel to the first clock main line; a second clock branch line group including a plurality of clock branch lines extending along the second direction and electrically connected to the second clock main line; a second clock driving cell electrically connected to the second clock branch line group; a second clock synchronous cell group including a plurality of clock synchronous cells electrically connected to the second clock main line or the second clock branch line group; and a clock source driver for providing a clock signal to the first clock driving cell and the second clock driving cell, and the first clock branch line group is electrically separated from the second clock branch line group, the first clock driving cell singly drives the first clock main line and the first clock branch line group, and the second clock driving cell singly drives the second clock main line and the second clock branch line group.

### BRIEF DESCRIPTION OF THE DRAWINGS

FIG. 1 is a layout diagram of a functional block 100 according to Embodiment 1 of the invention.

FIG. 2 is a diagram for showing exemplified connection of a second clock synchronous cell group 24 within a second region 20.

FIG. 3 is an enlarged layout diagram of a connecting portion between a second clock driving cell 23 and a second clock main line 21 and a connecting portion between a second clock branch line group 22 and the second clock synchronous cell group 24.

FIG. 4 is a cross-sectional view of the connecting portion between the second clock driving cell 23 and the second clock main line 21.

FIG. 5 is a layout diagram of a functional block 200 according to Embodiment 2 of the invention.

FIG. 6 is a diagram for showing an exemplified functional block including a first clock driving cell 13 and a second clock driving cell 23 with different driving performance.

FIG. 7 is a diagram for showing exemplified wiring of clock branch lines.

FIG. 8 is a diagram for showing another exemplified wiring of the clock branch lines.

FIG. 9 is a diagram for explaining a wiring method for the clock branch lines.

FIG. 10 is a layout diagram of a functional block 300 according to Embodiment 3 of the invention.

FIG. 11 is a diagram for showing exemplified division of the functional block 300.

FIG. 12 is a diagram for showing exemplified application of a clock distribution circuit of this invention to a functional block in a non-rectangular shape.

FIG. 13 is a diagram for showing another exemplified application of the clock distribution circuit of this invention to a functional block in a non-rectangular shape.

FIG. 14 is a layout diagram of a functional block 400 according to Embodiment 4 of the invention.

FIG. 15 is a diagram for showing exemplified arrangement of a second clock driving cell 23 and a third clock driving cell 33.

FIG. 16 is a layout diagram of a functional block 500 according to Embodiment 5 of the invention.

FIG. 17 is a diagram for showing exemplified division of the functional block 500.

FIG. 18 is a diagram for showing another exemplified division of the functional block 500.

FIG. 19 is a layout diagram of a functional block 600 according to Embodiment 6 of the invention.

FIG. 20 is a diagram for showing an exemplified functional block in which areas of different clock systems overlap.

FIG. 21 is a flowchart of a clock layout automating method according to Embodiment 7 of the invention.

### DETAILED DESCRIPTION OF THE INVENTION

Preferred embodiments of the invention will now be described with reference to the accompanying drawings. It is noted that like reference numerals are used to refer to like elements once described in the following embodiments so as to avoid the repetition of the description.

### Embodiment 1

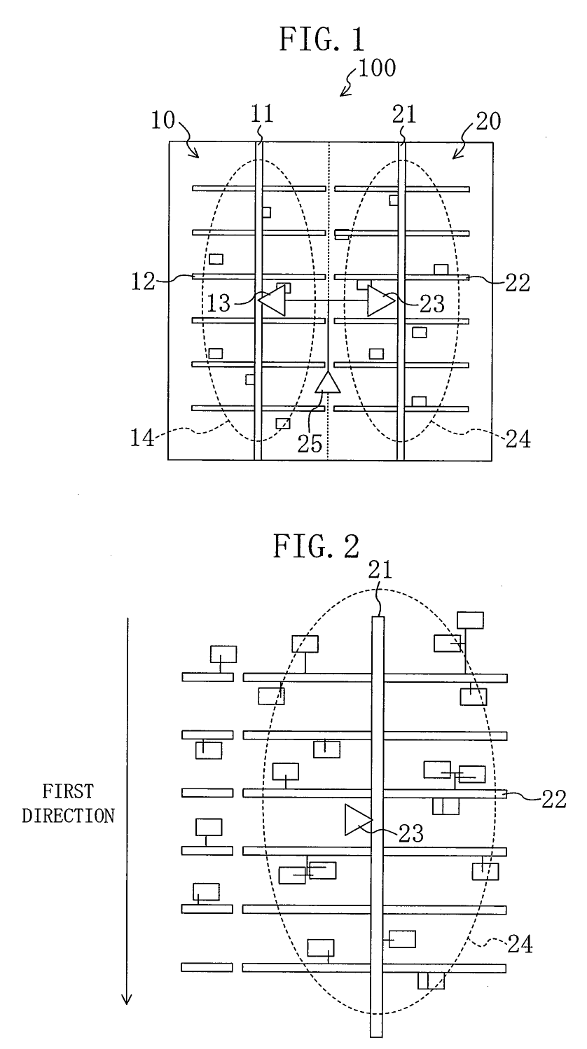

FIG. 1 is a layout diagram of a functional block 100 using a clock distribution circuit of this invention. The functional block 100 includes a circuit constructed by using standard cells. A standard cell is provided with a function as an inverter, a NAND or the like by combining a P-channel transistor and an N-channel transistor.

The functional block 100 is divided into a first region 10 and a second region 20.

In the first region 10, a clock main line, clock branch lines and a clock driving cell are provided.

Specifically, a first clock main line 11 is provided at the center of the first region 10 to extend along the vertical direction. A group of clock branch lines extends horizontally from the first clock main line 11 at equal intervals. It is noted that the “center” herein does not always mean the accurate center. In other words, the center may be a region that can be regarded as the center (hereinafter referred to as the vicinity of the center). Herein, the group of clock branch lines is designated as a first clock branch line group 12. In each drawing mentioned below, the reference numeral is representatively provided to one clock branch line belonging to the first clock branch line group 12.

Furthermore, an output terminal of a first clock driving cell 13 (described later) placed in the vicinity of the center of the first region 10 is connected to a portion in the vicinity of the center of the first clock main line 11.

In the first region 10, a first clock synchronous cell group 14 corresponding to a group of clock synchronous cells (surrounded with a dashed line ellipse in the drawing) is placed.

Each clock synchronous cell belonging to the first clock synchronous cell group 14 is electrically connected to the first clock main line 11 or the first clock branch line group 12.

Also in the second region 20, a clock main line, a clock branch line group and a clock driving cell are provided.

Specifically, a second clock main line 21 is provided in the vicinity of the center of the second region 20 so as to extend along the vertical direction, and a group of clock branch lines (i.e., a second clock branch line group 22) extends horizontally from the second clock main line 21 at equal intervals. In each drawing mentioned below, the reference numeral is representatively provided to one clock branch line belonging to the second clock branch line group 22.

Furthermore, an output terminal of a second clock driving cell 23 placed in the vicinity of the center of the second region 20 is connected to a portion in the vicinity of the center of the second clock main line 21.

Also in the second region 20, a second clock synchronous cell group 24 corresponding to a group of clock synchronous cells (surrounded with a dashed line ellipse in the drawing) is placed. Each clock synchronous cell belonging to the second clock synchronous cell group 24 is electrically connected to the second clock main line 21 or the second clock branch line group 22.

The first clock driving cell 13 receives, as an input, a clock signal output from a clock source driver 25 (described later) and distributes the same clock signal to the respective clock synchronous cells belonging to the first clock synchronous cell group 14 through the first clock main line 11 and the first clock branch line group 12.

Also, the second clock driving cell 23 receives, as an input, the clock signal output from the clock source driver 25 and distributes the same clock signal to the respective clock synchronous cells belonging to the second clock synchronous cell group 24 through the second clock main line 21 and the second clock branch line group 24.

In this case, each of the first clock driving cell 13 and the second clock driving cell 23 is a standard cell provided with a function as a buffer or an inverter, and each clock synchronous cell is a clock control cell that control clock supply to a flip-flop or frip-flop.

Furthermore, the first clock branch line group 12 and the second clock branch line group 22 are electrically separated from each other.

The clock source driver 25 receives, as an input, a clock signal from the outside of the functional block 100 and supplies the clock signal to the first clock driving cell 13 and the second clock driving cell 23.

As described above, in this embodiment, the first clock driving cell 13 drives merely the first clock main line 11, the first clock branch line group 12 and the first clock synchronous cell group 14 placed within the first region 10. Therefore, as compared with the case where it drives the clock signal in the whole functional block, the load capacitance to be driven can be substantially halved. In other words, the first clock driving cell 13 can singly drive the entire first clock synchronous cell group 14 placed within the first region 10.

Also, the second clock driving cell 23 drives merely the second clock main line 21, the second clock branch line group 22 and the second clock synchronous cell group 24 placed within the second region 20. Therefore, the second clock driving cell 23 can singly drive the entire second clock synchronous cell group 24 placed within the second region 20.

In other words, according to this embodiment, the number of clock synchronous cells to be driven by one clock driving cell can be reduced, and as a result, the total length of clock branch lines can be reduced, so that the load to be driven by the one clock driving cell can be reduced. Accordingly, one high-drive clock driving cell can singly drive a clock main line, clock branch lines and clock synchronous cells placed within a corresponding region.

Furthermore, since the clock wiring structures from the clock driving cell to the respective clock synchronous cells can be made uniform, wiring delay variation is small.

Moreover, delay can be calculated by using a delay calculation tool of a standard cell level currently commercially available. In the case where one signal line is driven by a plurality of clock driving cells, the delay cannot be precisely calculated with the currently commercially available delay calculation tool of a standard cell level, and the thus calculated delay disadvantageously has a large error. Therefore, it is conventionally necessary to perform the delay calculation by using a simulator of a transistor level on merely a portion corresponding to the comb clock wiring or the mesh clock wiring. As a result, there arise problems that the number of procedures necessary for timing assurance of a semiconductor integrated circuit is increased, that the influence of crosstalk and the like cannot be correctly taken into consideration and that the accuracy in the delay calculation is lowered. On the contrary, according to this embodiment, since merely one clock driving cell is used for driving, such problems can be overcome.

Also, the clock branch lines can be provided uniformly in the corresponding region, and the wiring delay variation can be reduced regardless of the location of the clock synchronous cells.

Furthermore, since the functional block is divided into a plurality of regions, a clock tree can be optimized in each of the regions.

Since the functional block 100 is divided in the vertical direction, the first clock main line 11 and the second clock main line 21 are very long. However, when the first clock main line 11 and the second clock main line 21 are formed by using an upper layer interconnection with a large thickness, the wiring resistance of the clock main lines can be reduced. Accordingly, even though the first clock main line 11 and the second clock main line 21 are long, the clock skew caused between the center and the end of the clock main line can be made very small. Also, in this case, a distance from the clock main line to the end of a clock branch line corresponds to ¼ of the lateral width of the functional block 100. Therefore, since the wiring resistance up to the end of the clock branch line is small, the wiring delay variation caused between the center and the end of the clock branch line can be made small. In other words, the clock skew caused in the clock main line and the clock branch lines can be made small. Furthermore, since the resistance is small, a large number of clock synchronous cells can be driven at a time by the high-drive clock driving cell, and hence, the clock skew can be reduced.

Moreover, when the clock main line is made of an upper layer interconnection having a large thickness and further having a large width, the wiring resistance can be further reduced.

FIG. 2 is a diagram for showing exemplified connection of the second clock synchronous cell group 24 within the second region 20. In FIG. 2, the second clock synchronous cell group 24 is placed in a region defined in accordance with the vertical direction of the second clock main line 21 and the horizontal direction of the second clock branch line group 22. A clock synchronous cell of the second clock synchronous cell group 24 placed in the vicinity of the second clock main line 21 is directly connected to the second clock main line 21 and each of the other clock synchronous cells of the second clock synchronous cell group 24 is directly connected to any clock branch line placed at the smallest distance in the upper or lower direction. Accordingly, since the wire length from the clock branch line or the clock main line to each of the clock synchronous cells is small, the wiring delay can be small even when a lower layer interconnection with a small thickness is used for the connection.

Furthermore, as shown in FIGS. 1 and 2, the respective clock branch lines are preferably placed over the corresponding region at constant intervals. Thus, even when the location of the clock synchronous cells is varied, the cells can be connected with the shortest wires.

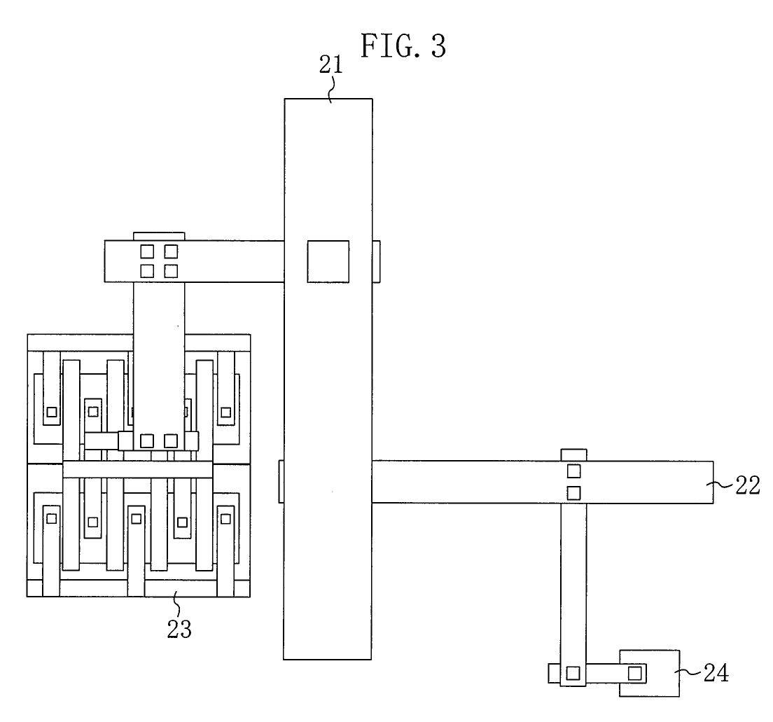

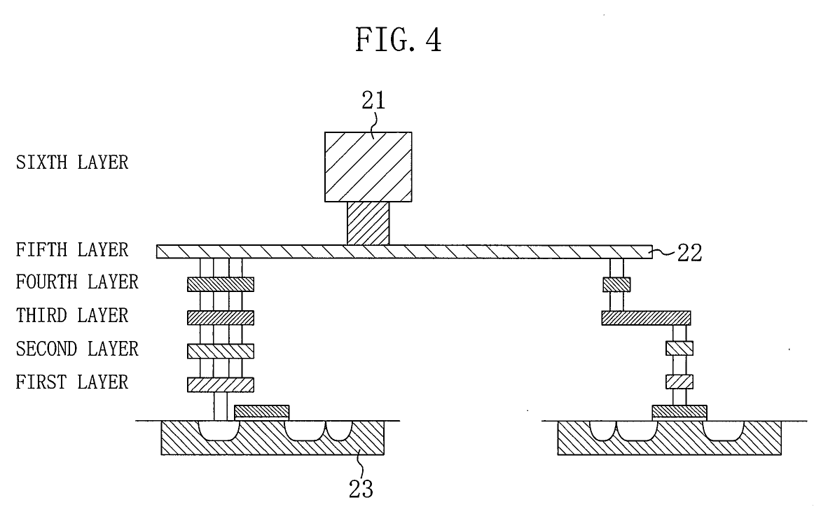

FIG. 3 is an enlarged layout diagram of a connecting portion between the second clock driving cell 23 and the second clock main line 21 and a connecting portion between the second clock branch line group 22 and the second clock synchronous cell group 24 shown in FIG. 2. Also, FIG. 4 is a cross-sectional view of the connecting portion between the second clock driving cell 23 and the second clock main line 21.

In FIGS. 3 and 4, interconnection layers of the functional block 100 are formed as six-layered interconnections of first through sixth layers. Also, contacts for connecting the respective interconnection layers are provided between the interconnection layers.

Each of the interconnection layers of the first through fifth layers has a small thickness. Therefore, the sheet resistance is large. On the other hand, the interconnection layer of the sixth layer has a thickness not less than five times as large as the thickness of the first through fifth layers, and hence, the sheet resistance is ⅕. When the thickness is large, it is necessary to increase the line width owing to the restriction in the fabrication process. Therefore, the number of interconnections that can be formed in the sixth layer is small. However, since the upper layer interconnection with the large thickness is used for the clock main line alone, the use of the upper layer interconnection can be minimized. In other words, the use of the upper layer interconnection for a clock signal can be restricted by employing this structure.

In FIG. 3, the second clock driving cell 23 is a standard cell provided with a function as an inverter by using a P-channel transistor and an N-channel transistor. In this case, the output terminal of the second clock driving cell 23 is connected through the interconnection of the first to fifth layer and contacts to the vicinity of the center of the second clock main line 21 in the sixth layer.

The second clock driving cell 23 should drive all the clock synchronous cells placed within the second region 20. Therefore, the second clock driving cell 23 has very high driving performance, and hence, current density in a portion between the second clock driving cell 23 and the second clock main line 21 is very large, which may cause a problem of line disconnection due to electro-migration. Accordingly, it is necessary to reduce the current density of currents passing through the interconnections and the contacts in the portion between the second clock driving cell 23 and the second clock main line 21. For this purpose, wide interconnections and a plurality of contacts are used for the connection. Thus, the resistance from the clock driving cell to the clock main line can be reduced. Therefore, a large number of clock synchronous cells can be driven at a time by the high-drive clock driving cell, so as to reduce the clock skew.

Also, in FIG. 4, the second clock main line 21 is connected to the second clock branch line group 22 formed by the fifth interconnection layer, and the second clock branch line group 22 is connected to the second clock synchronous cell group 24 through the interconnections of the fourth through second layers. Accordingly, each interconnection used between the second clock branch line group 22 and the second clock synchronous cell group 24 has a short length and is connected to small load capacitance, and therefore, the wiring delay is small even though the interconnections having the minimum widths owing to the process restriction are used.

Furthermore, the clock main line is connected to the plural clock branch lines so that a current can be dispersed from the clock main line to the clock branch lines. Therefore, the current density can be reduced in the clock branch lines and the interconnections used between the clock branch lines and the clock synchronous cells, and hence, the problem of the electro-migration can be avoided even with the minimum line widths.

The lower layer interconnections have a merit that there are many routing resources although they have high resistance, and since the clock synchronous cells are large in the number, if an upper layer interconnection or a wide interconnection of a lower layer interconnection is used for connecting the clock branch lines and the clock synchronous cells, a shortage of routing resources occur. On the contrary, as described above, the clock driving cells are connected to the clock main line provided in the upper layer through the wide interconnections and the plural contacts, the upper layer interconnection with the large thickness is used for the clock main line alone and the clock branch lines are connected to the clock synchronous cells through the lower layer interconnections with the minimum widths. Thus, the wiring resistance on the side of the driver that is dominant in the wiring delay can be made small, so as to reduce the clock skew as well as secure the routing resources.

### Embodiment 2

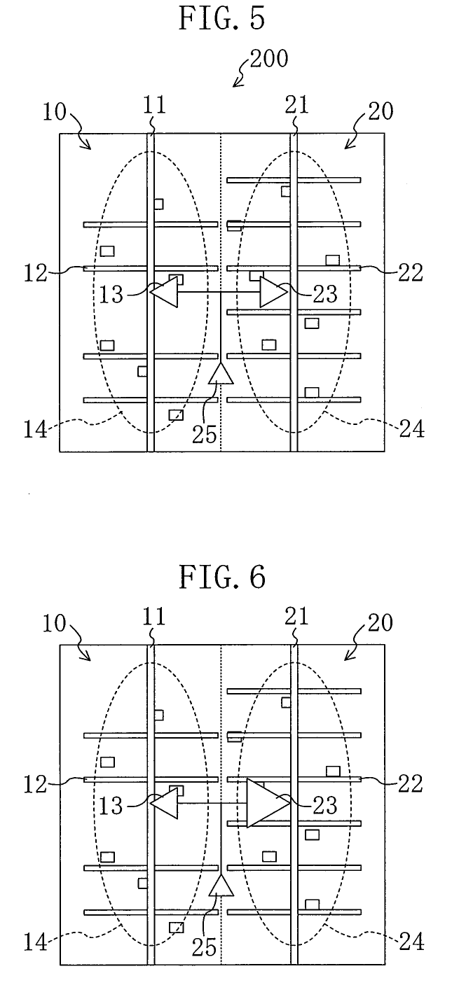

FIG. 5 is a layout diagram of a functional block 200 according to Embodiment 2 of the invention. In the functional block 200, a first clock branch line group 12 includes four clock branch lines and a second clock branch line group 22 includes six clock branch lines as shown in FIG. 5. When clock branch lines having no clock synchronous cells nearby are thus omitted in the first clock branch line group 12, the wiring capacitance can be reduced so as to reduce the power consumption.

In FIG. 5, the load capacitance to be driven is different between a first clock driving cell 13 and a second clock driving cell 23. Therefore, if the first clock driving cell 13 and the second clock driving cell 23 have the same driving performance, the resultant signal transition time is different between them, so as to increase the clock skew of the whole functional block.

Therefore, the driving performance of the clock driving cell is determined in accordance with the reduction ratio of the load capacitance to be driven by the clock driving cell. FIG. 6 shows an exemplified functional block in which the driving performance is different between a first clock driving cell 13 and a second clock driving cell 23, and the clock driving cell with the lower performance is shown with a smaller symbol in the drawing. In the example of FIG. 6, the driving performance of the first clock driving cell 13 is reduced in accordance with the reduction ratio of the load capacitance to be driven by the first clock driving cell 13. Thus, while attaining the same signal transition time of the first clock driving cell 13 and the second clock driving cell 23, the power consumption can be reduced.

It is noted that a redundant wiring portion of clock branch lines can be eliminated by providing clock branch lines in accordance with the location of clock synchronous cells previously determined. Thus, the total length of the clock branch lines can be reduced, and therefore, a routing resources obtained as a result of the reduction can be used for a general signal line.

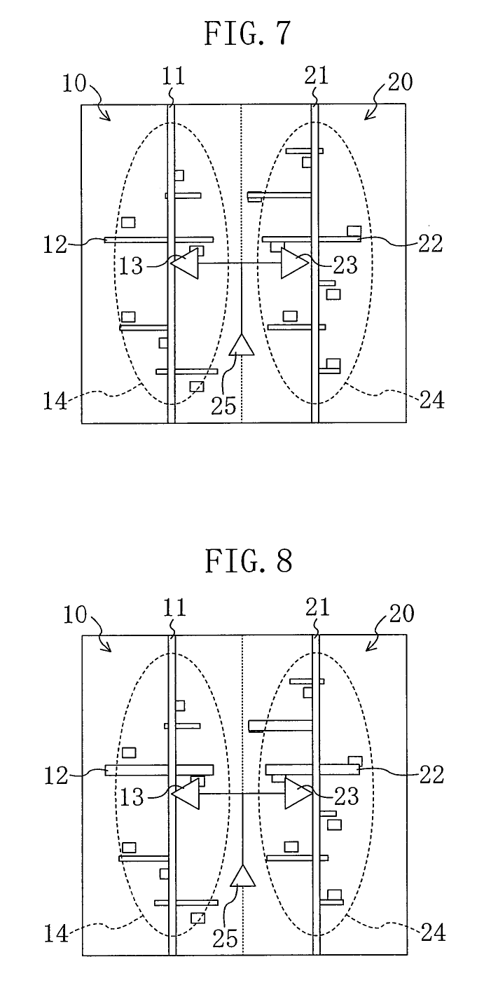

Furthermore, the clock branch lines are preferably extended to portions where the clock synchronous cells are placed as shown in FIG. 7. In other words, the first clock branch line group 12 and the second clock branch line group 22 are respectively provided bilaterally symmetrically about the first clock main line 11 and the second clock main line 21. Thus, the wiring load capacitance can be reduced so as to reduce the power consumption.

Moreover, the clock branch lines are preferably varied in the line width in accordance with the line length as shown in FIG. 8. A length up to a clock synchronous cell placed in the distance from the clock main line is large, and hence the wiring delay is large and the clock skew is large. However, when a clock branch line has a width increased in proportion to its length, variation in the wiring resistance up to the clock synchronous cell can be reduced, and as a result, the clock skew of the clock branch line connected to the clock synchronous cell placed in the distance from the clock branch line can be reduced. In contrast, a clock branch line connected to a clock synchronous cell placed in the vicinity of the clock main line is reduced in the width so as to reduce the wiring capacitance.

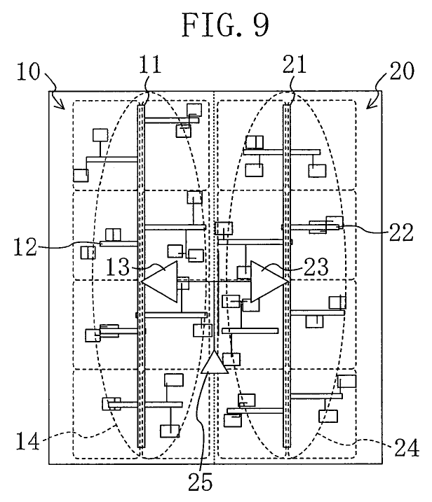

The method for providing the clock branch lines in the aforementioned manner will now be described with reference to FIG. 9.

In FIG. 9, each of a first region 10 and a second region 20 is divided into eight sub-regions. One clock branch line is provided in each of the sub-regions. The clock branch line is placed to extend horizontally in a position corresponding to the center of gravity of clock synchronous cell group provided in that sub-region. Each clock branch line is extended from the clock main line to a clock synchronous cell placed at the end of the sub-region. Thus, redundant lines can be eliminated so as to reduce the power consumption.

### Embodiment 3

Although the respective regions (such as the first region 10) have the same size in each of the above-described embodiments, a functional block is divided into regions with different sizes in Embodiment 3.

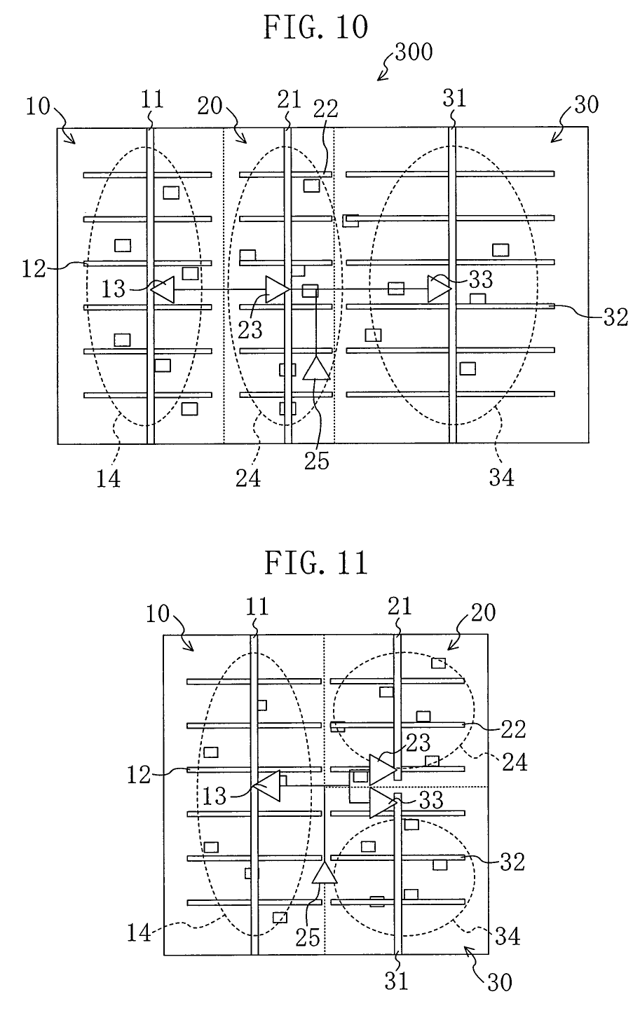

FIG. 10 is a layout diagram of a functional block 300 according to Embodiment 3 of the invention. The functional block 300 is divided into a first region 10, a second region 20 and a third region 30 as shown in FIG. 10.

In the third region 30, a third clock main line 31 is provided to extend in the vertical direction in the vicinity of the center. A group of clock branch lines (a third clock branch line group 32) is extended from the third clock main line 31 in the horizontal direction. Also, an output terminal of a third clock driving cell 33 placed in the vicinity of the center of the third region 30 is connected to a portion in the vicinity of the center of the third clock main line 31.

The sizes of the first region 10, the second region 20 and the third region 30 are determined so that the number of clock synchronous cells provided in the respective regions can be the same.

In the case where the location of a clock synchronous cell group is biased, if a functional block is evenly divided, one region includes a large number of clock synchronous cells and another region includes a small number of clock synchronous cells, and thus, the load capacitance to be driven by a clock driving cell is different among the respective regions. In such a case, the signal transition time is different among the clock driving cells, so as to increase the clock skew of the whole functional block.

When a functional block is divided in the aforementioned manner so as to equalize the load, however, even if the location of clock synchronous cells is biased, the numbers of clock synchronous cells to be driven by the respective clock driving cells can be equalized. Therefore, even when a first clock driving cell 13, a second clock driving cell 23 and a third clock driving cell 33 have the same driving performance, the signal transition time can be the same and the clock skew of the whole functional block can be reduced.

Although the functional block is divided so that the respective regions include the same number of clock synchronous cells in FIG. 10, the functional block may be divided so that sum of the input capacitance of clock synchronous cells and wire capacitance of clock signals can be the same in the respective regions.

FIG. 11 shows another exemplified division of the functional block 300. In this functional block 300, the second region 20 of FIG. 1 is further divided into two regions. Therefore, this functional block is divided into a first region 10, and a second region 20 and a third region 30 adjacent to each other in the vertical direction. In the example of FIG. 11, a third clock main line 31 is placed beneath a second clock main line 21 so as to extend along a first direction. In this case, to be “beneath” the second clock main line 21 means to be on a side of the second clock main line 21 in the forward or reverse direction of the first direction (see FIG. 2).

Also, in this example, the total area of the second region 20 and the third region 30 is equal to the area of the first region 10. Furthermore, the sum of the number of clock synchronous cells of a second clock synchronous cell group 24 and the number of clock synchronous cells of a third clock synchronous cell group 34 is larger than the number of clock synchronous cells of a first clock synchronous cell group 14.

A region where clock synchronous cells are densely placed due to biased location of a clock synchronous cell group is further divided into a plurality of regions in this manner, so that the clock synchronous cells can be driven by a clock driving cell provided in each of the regions.

Therefore, in the above-described example, the load capacitance to be driven by each of a second clock driving cell 23 and a third clock driving cell 33 can be reduced so as to equalize the load capacitance to be respectively driven by a first clock driving cell 13, the second clock driving cell 23 and the third clock driving cell 33. Furthermore, when the second clock driving cell 23 and the third clock driving cell 33 are placed in the same position in the vertical direction as the first clock driving cell 13, the line lengths from a clock source driver 25 to the first clock driving cell 13, the second clock driving cell 23 and the third clock driving cell 33 can be made the same.

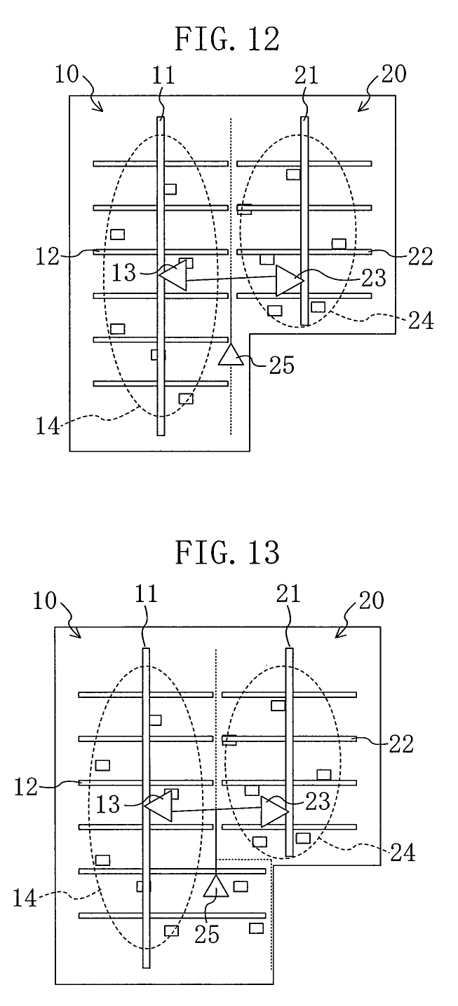

FIG. 12 shows exemplified application of the aforementioned clock distribution circuit to a functional block in a non-rectangular shape. In this example, a second region 20 has a shorter length along the vertical direction than a first region 10.

In this case, the length along the vertical direction of a second clock main line 21 is reduced in accordance with the vertical length of the second region 20. Also, since the second region 20 thus has a smaller area, the number of clock branch lines belonging to a second clock branch line group 22 is smaller. Therefore, the load capacitance to be driven by a second clock driving cell 23 is smaller. In other words, when the driving performance of the second clock driving cell 23 is reduced in accordance with the smaller load capacitance, the power consumption can be reduced while reducing the clock skew.

When the first clock driving cell 13 and the second clock driving cell 23 are placed in the same position along the horizontal direction, the position of the second clock driving cell 23 is shifted from the center of the second region 20, but the clock skew of the clock main line can be reduced by using an upper layer interconnection with lower resistance for the second clock main line 21.

Furthermore, although a functional block in a non-rectangular shape is shown in FIG. 12, even when it is in a rectangular shape, the length of a clock main line can be reduced in a portion having no clock synchronous cells to be connected.

Moreover, although each divided region is in a rectangular shape in FIG. 12, each region may be in a non-rectangular shape. For example, in an example shown in FIG. 13, a first region 10 is in a non-rectangular shape having a lower side longer than an upper side. In this example, clock branch lines of a first clock branch line group 12 have a longer length in a lower portion than in an upper portion in accordance with the shape of the first region 10. Therefore, a first clock synchronous cell group 14 placed in the non-rectangular first region 10 can be connected to the first clock branch line group 12 with the shortest line lengths.

### Embodiment 4

In Embodiment 4 of the invention, an example of a functional block including a hard macro such as an SRAM (static random access memory) will be described.

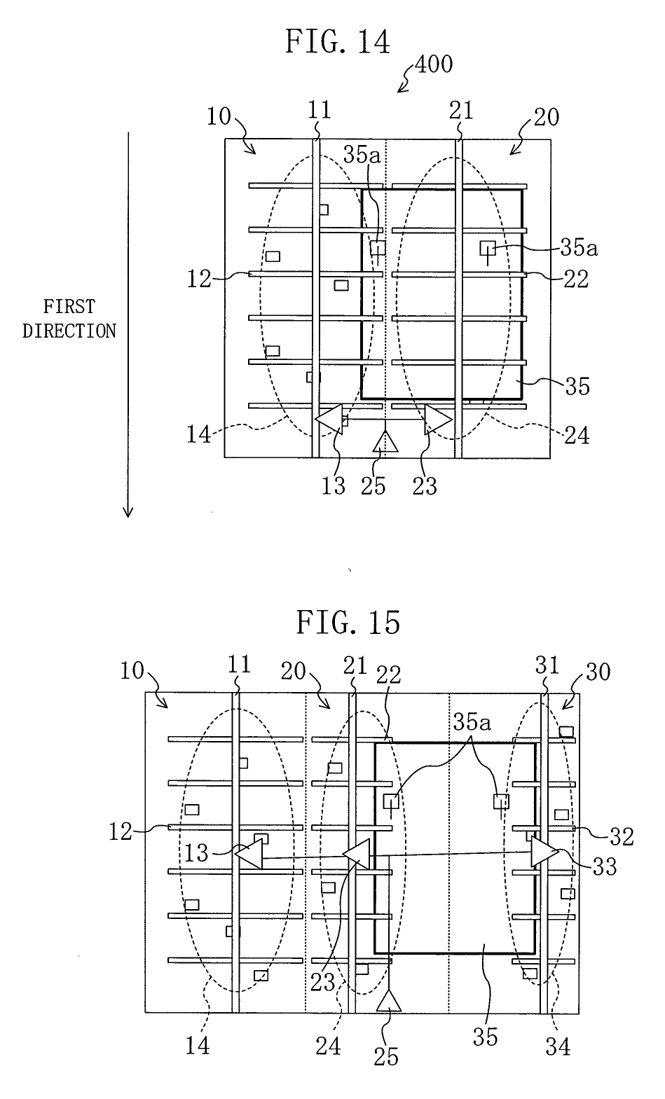

FIG. 14 is a layout diagram of a functional block 400 according to Embodiment 4 of the invention. The functional block 400 includes a hard macro 35. The hard macro 35 is placed to extend over a first region 10 and a second region 20.

As shown in FIG. 14, the center portion of the second region 20 is occupied by the hard macro 35. Accordingly, in the functional block 400, a second clock driving cell 23 cannot be placed in the vicinity of the center of the second region 20. Therefore, the second clock driving cell 23 is placed in a lower portion of the second region 20 in the functional block 400 so as not to overlap the hard macro 35. Thus, the position of the second clock driving cell 23 is shifted from the vicinity of the center of the second region 20. However, since an upper layer interconnection with low resistance is used for a second clock main line 21, when the second clock driving cell 23 is placed in the vicinity of the end of the second clock main line 21 so as to be connected to the second clock main line 21 with the shortest line, the influence on the clock skew of the whole functional block can be sufficiently reduced.

Also, a first clock driving cell 13 is shifted in the vertical direction to the same position as the second clock driving cell 23. Thus, a distance from the first clock driving cell 13 to a clock source driver 25 and a distance from the second clock driving cell 23 to the clock source driver 25 can be the same. In other words, the clock skew from the clock source driver 25 can be reduced.

Furthermore, the hard macro 35 may have a plurality of clock connection pins. In the example shown in FIG. 14, the hard macro 35 has two clock connection pins 35a respectively placed in the first region 10 and the second region 20. Therefore, the clock connection pin 35a placed in the first region 10 is connected to the first clock driving cell 13, and the clock connection pin 35a placed in the second region 20 is connected to the second clock driving cell 23. Thus, a clock branch line can be connected to the clock connection pin with the shortest line.

In the case where the input capacitance of a clock connection pin is large, the wiring delay up to the clock connection pin may be large or the load capacitance to be driven by a clock driving cell may be very large, and hence, the transition time of a clock signal waveform becomes large so as to increase the clock skew. However, when a plurality of clock connection pins are provided as described above so as to drive the respective clock connection pins by different clock driving cells or to be connected to different branch lines, the wiring delay up to each clock connection pin can be reduced and the load capacitance to be driven by each clock driving cell can be reduced.

Alternatively, as shown in FIG. 15, a second clock driving cell 23 and a third clock driving cell 33 may be placed in the same position in the horizontal direction as a first clock driving cell 13. In the example shown in FIG. 15, a functional block is divided into a first region 10, a second region 20 and a third region 30. Furthermore, a hard macro 35 is placed so as to extend over the second region 20 and the third region 30. More specifically, the hard macro 35 occupies the center portions of the second region 20 and the third region 30, and therefore, the second clock driving cell 23 and the third clock driving cell 33 cannot be placed in the vicinity of the centers of the second region 20 and the third region 30, respectively. Accordingly, the second clock driving cell 23 and the third clock driving cell 33 are shifted in the horizontal direction so as not to overlap the hard macro 35. In this case, a second clock main line 21 and a third clock main line 31 are also respectively shifted to the same position in the vertical direction as the second clock driving cell 23 and the third clock driving cell 33, so as to reduce the wiring delay from each clock driving cell to the corresponding clock main line and to prevent increase of the clock skew.

Furthermore, since the hard macro is sandwiched between the clock main lines in the lateral direction, clocks can be supplied to the hard macro from both the second clock main line 21 and the third clock main line 31. In other words, the wiring delay can be thus reduced.

With the first clock driving cell 13 and the second clock driving cell 23 aligned as shown in FIG. 15, a portion from a clock source driver 25 to each clock connection pin of the first clock driving cell 13 and the second clock driving cell 23 may be constructed by using a buffer tree of a plurality of stages respectively having the same line length. Thus, the wiring delay of the respective stages of the buffer tree can be equalized, so as to reduce the clock skew from the clock source driver 25.

### Embodiment 5

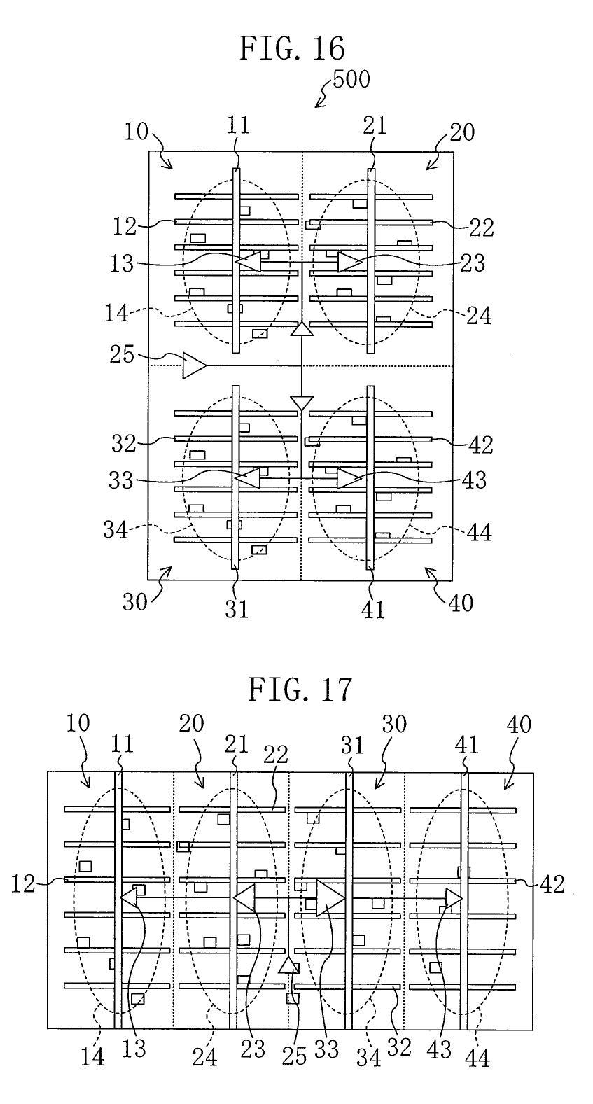

In Embodiment 5 of the invention, the clock distribution circuit of this invention is applied to a large scale circuit. FIG. 16 is a layout diagram of a functional block 500 according to Embodiment 5 of the invention.

The functional block 500 is divided into a first region 10, a second region 20, a third region 30 and a fourth region 40 as shown in FIG. 16. In this example, the third region 30 and the fourth region 40 are respectively placed beneath the first region 10 and the second region 20.

In the fourth region 40, a fourth clock main line 41 is provided so as to extend in the vertical direction in the vicinity of the center of the region, and a group of clock branch lines (a fourth clock branch line group 42) is extended from the fourth clock main line 41 in the horizontal direction. An output terminal of a fourth clock driving cell 43 placed in the vicinity of the center of the fourth region 40 is connected to a portion in the vicinity of the center of the fourth clock main line 41.

Furthermore, a fourth clock synchronous cell group 44 is placed within the fourth region 40. The fourth clock synchronous cell group 44 is electrically connected to the fourth clock main line 41 or the fourth clock branch line group 42.

A clock signal output from the same clock source driver 25 is input through relay buffers to a first clock driving cell 13, a second clock driving cell 23, a third clock driving cell 33 and the fourth clock driving cell 43 so as to distribute the same clock signal. At this point, when the line lengths from the clock source driver 25 to the respective relay buffers and the line lengths from the relay buffers to the respective clock driving cells are the same, the wiring delay of respective stages can be equalized.

In this manner, the functional block 500 is divided not only in the vertical direction but also in the horizontal direction, so as to shorten the length of each clock main line for reducing the wiring delay of the clock main line. Moreover, since the number of clock synchronous cells placed in each region is thus reduced, the load capacitance to be driven by each clock driving cell can be reduced. In other words, one clock driving cell can singly drive a clock main line, a clock branch line group and clock synchronous cells placed in one region.

It is noted that a functional block can be vertically divided into three or more regions in accordance with the size of the functional block.

Furthermore, a portion from the clock source driver 25 to each clock connection pin of the first clock driving cell 13 and the second clock driving cell 23 may be constructed by using a buffer tree of a plurality of stages respectively having the same line length and a portion from the clock source driver 25 to each clock connection pin of the third clock driving cell 33 and the fourth clock driving cell 43 may be constructed by using another buffer tree of a plurality of stages respectively having the same line length. Thus, even when the functional block has a large length along the first direction, the length of each clock main line can be reduced and the number of clock synchronous cells to be driven by each clock driving cell can be reduced by dividing the functional block into a plurality of regions.

It is noted that the buffer tree used for the portion between the clock source driver 25 and the first and second clock driving cells 13 and 23 and the buffer tree used for the portion between the clock source driver 25 and the third and fourth clock driving cells 33 and 43 may be shared. When the buffer trees are thus shared, relay buffers and clock lines used in the buffer trees can be partly shared, so as to reduce the power consumption.

A functional block exemplified in FIG. 17 is vertically divided into a first region 10, a second region 20, a third region 30 and a fourth region 40. Also in this example, a clock main line, a clock branch line group and a clock driving cell are placed in each region. In other words, when a functional block is optimally divided into regions in accordance with its size, the clock load capacitance within each region can be below the load capacitance that can be driven by one clock driving cell.

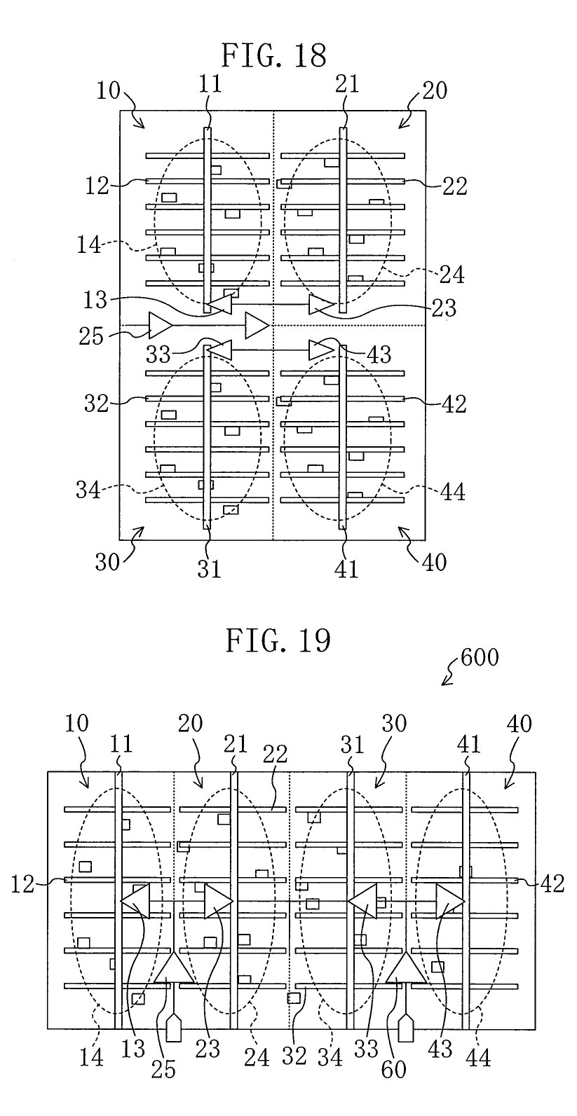

Furthermore, a functional block may be divided as shown in FIG. 18.

The functional block shown in FIG. 18 is divided into a first region 10, a second region 20, a third region 30 and a fourth region 40. The third region 30 and the fourth region 40 are respectively placed beneath the first region 10 and the second region 20.

A clock signal output from the same clock source driver 25 is input through the same relay buffer to a first clock driving cell 13, a second clock driving cell 23, a third clock driving cell 33 and a fourth clock driving cell 43 so as to distribute the same clock signal. When the respective clock driving cells are thus placed in positions close to the relay buffer, the relay buffer can be shared and the line lengths can be reduced. Thus, the power consumption can be reduced.

### Embodiment 6

In Embodiment 6 of the invention, the clock distribution circuit of this invention is applied to a circuit including a plurality of clock systems. FIG. 19 is a layout diagram of a functional block 600 according to Embodiment 6.

As shown in FIG. 19, the functional block 600 is divided into a first region 10, a second region 20, a third region 30 and a fourth region 40. A clock main line, a clock branch line group and a clock driving cell are placed in each region. A first clock synchronous cell group 14, a second clock synchronous cell group 24, a third clock synchronous cell group 34 and a fourth clock synchronous cell group 44 are respectively placed in the first, second, third and fourth regions so as to be driven respectively by a first clock driving cell 13, a second clock driving cell 23, a third clock driving cell 33 and a fourth clock driving cell 43.

Furthermore, the first clock driving cell 13 and the second clock driving cell 23 are driven by a clock source driver 25, and the third clock driving cell 33 and the fourth clock driving cell 43 are driven by a clock source driver 60. In other words, when different clocks are respectively input to the clock source driver 25 and the clock source driver 60, a plurality of clock systems can be used in the functional block.

Specifically, in this embodiment, clock synchronous cells are placed in the respective regions with respect to the respective clock systems, and the clock main line, the clock branch line group and the clock driving cell are placed in each of the regions.

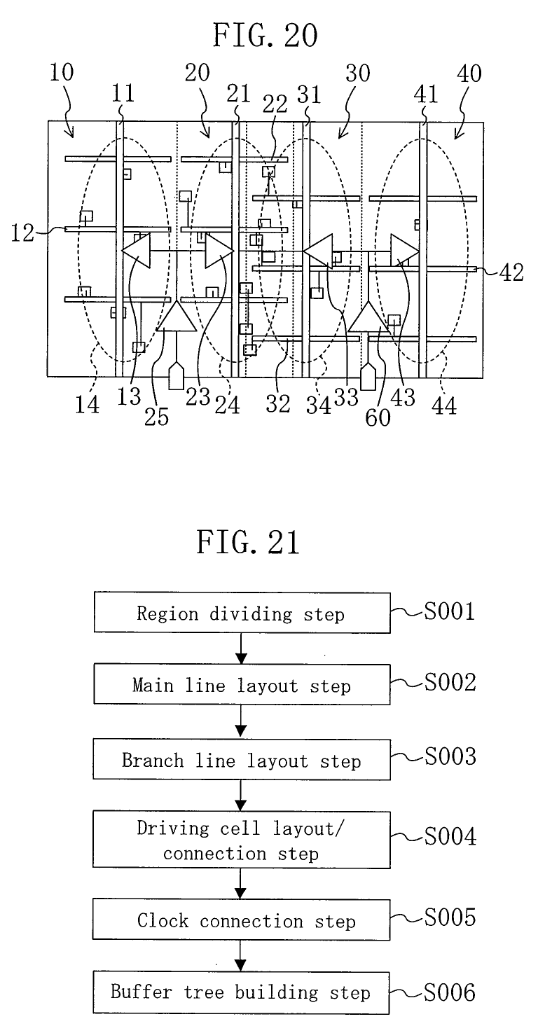

It is noted that areas of different clock systems may overlap each other. For example, in an exemplified functional block shown in FIG. 20, a second region 20 and a third region 30 partly overlap. In such a case, the horizontal positions of a second clock branch line group 22 and a third clock branch line group 32 are shifted from each other as shown in the drawing. Thus, even when clock synchronous cells of different systems are placed in one region, different clocks can be respectively supplied by employing the structure of this invention.

### Embodiment 7

In Embodiment 7 of the invention, a method for automatically realizing the aforementioned clock distribution circuit will be described. FIG. 21 is a flowchart of a clock layout automating method of this embodiment. This automating method includes a region dividing step S001, a main line placement step S002, a branch line placement step S003, a driving cell placement/connection step S004, a clock connection step S005 and a buffer tree building step S006. Procedures in the respective steps are as follows:

First, in the region dividing step S001, a functional block is divided into a plurality of region along a first direction (see FIG. 2).

In the main line placement step S002, a clock main line is placed at the center of each region so as to extend along the first direction by using an upper layer interconnection with a large thickness.

In the branch line placement step S003, a plurality of clock branch lines are placed so as to extend along a second direction perpendicular to the first direction with the clock main line set as the center.

In the driving cell placement/connection step S004, a clock driving cell for driving the clock main line and the clock branch lines is placed at the center of each region, and a line for connecting the clock driving cell to the clock main line is formed.

In the clock connection step S005, lines for connecting clock synchronous cells placed within each region to the clock main line or any clock branch line placed nearby within the same region are formed.

In the buffer tree building step S006, a buffer tree extending from a clock source driver to the clock driving cell is built.

In other words, according to the clock layout automating method, when a method for dividing a functional block and the structure of a buffer tree are input, the functional block is divided into regions by the specified method. Next, a clock main line, a clock branch line group and a clock driving cell are placed in each region. Then, the connection of clock synchronous cells placed within each region is changed to be connected to the clock driving cell placed within the same region, and lines for connecting the clock synchronous cells to a clock main line or a clock branch line placed nearby are formed. Thereafter, a buffer tree is built in a portion from a clock source driver to the clock driving cell by the specified buffer tree structure.

As described so far, according to the present invention, the power consumption and the clock skew can be reduced, and the load capacitance to be driven by a clock driving cell can be reduced even in a large scale semiconductor integrated circuit. Therefore, the invention is useful for a clock distribution circuit or the like for distributing a clock signal in a functional block formed on a semiconductor integrated circuit by using standard cells.

What is claimed is:

1. A semiconductor integrated circuit comprising a clock distribution circuit for distributing a clock signal in a functional block constructed by using standard cells, the clock distribution circuit including:
a first clock main line extending along a first direction;
a first clock branch line group including a plurality of clock branch lines extending along a second direction perpendicular to the first direction and electrically connected to the first clock main line;
a first clock driving cell electrically connected to the first clock main line;
a first clock synchronous cell group including a plurality of clock synchronous cells electrically connected to the first clock main line or the first clock branch line group;
a second clock main line extending in parallel to the first clock main line;
a second clock branch line group including a plurality of clock branch lines extending along the second direction and electrically connected to the second clock main line;
a second clock driving cell electrically connected to the second clock main line;
a second clock synchronous cell group including a plurality of clock synchronous cells electrically connected to the second clock main line or the second clock branch line group; and
a clock source driver for providing a clock signal to the first clock driving cell and the second clock driving cell,
the first clock branch line group being electrically separated from the second clock branch line group,
the first clock driving cell singly driving the first clock main line and the first clock branch line group,
the second clock driving cell singly driving the second clock main line and the second clock branch line group.

2. The semiconductor integrated circuit of claim 1,
wherein the semiconductor integrated circuit includes a plurality of interconnection layers having a large thickness in an upper layer and a small thickness in a lower layer,
the first clock main line and the second clock main line are formed by using an interconnection of the upper layer with a large thickness,
each of the plurality of clock synchronous cells included in the first clock synchronous cell group is connected, by using an interconnection of the lower layer with a small thickness, to the first clock main line or the first clock branch line group placed in a position at a shortest distance along a forward or reverse direction of the first direction, and
each of the plurality of clock synchronous cells included in the second clock synchronous cell group is connected, by using an interconnection of the lower layer with a small thickness, to the second clock main line or the second clock branch line group placed in a position at a shortest distance along a forward or reverse direction of the first direction.

3. The semiconductor integrated circuit of claim 1,
wherein a first region whose range along the first direction is defined by the first clock main line and whose range along the second direction is defined by the first clock branch line group and a second region whose range along the first direction is defined by the second clock main line and whose range along the second direction is defined by the second clock branch line group are exclusive from each other,
the first clock synchronous cell group is placed in the first region,
the second clock synchronous cell group is placed in the second region,
the first clock main line is placed at a center of the first region, and
the second clock main line is placed at a center of the second region.

4. The semiconductor integrated circuit of claim 1,
wherein a line path for connecting the first clock driving cell to the first clock main line and a line path for connecting the second clock driving cell to the second clock main line are formed by using lines with a large width and a plurality of contacts.

5. The semiconductor integrated circuit of claim 1,
wherein the plurality of clock branch lines included in the first clock branch line group are placed bilaterally symmetrically about the first clock main line at constant intervals along the first direction, and
the plurality of clock branch lines included in the second clock branch line group are placed bilaterally symmetrically about the second clock main line at constant intervals along the first direction.

6. The semiconductor integrated circuit of claim 1,
wherein the number of the plurality of clock branch lines included in the first clock branch line group is different from the number of the plurality of clock branch lines included in the second clock branch line group.

7. The semiconductor integrated circuit of claim 1,
wherein the first clock driving cell is placed at a center of the first clock main line,
the second clock driving cell is placed at a center of the second clock main line, and
the first clock driving cell and the second clock driving cell have different driving performance.

8. The semiconductor integrated circuit of claim 1,
wherein the plurality of clock branch lines included in the first clock branch line group are placed bilaterally asymmetrically about the first clock main line, and
some of the plurality of clock branch lines included in the first clock branch line group have a different length.

9. The semiconductor integrated circuit of claim 1,
wherein the plurality of clock branch lines included in the first clock branch line group are placed bilaterally asymmetrically about the first clock main line, and
some of the plurality of clock branch lines included in the first clock branch line group have a different length and a different width.

10. The semiconductor integrated circuit of claim 1,
wherein the clock distribution circuit further includes:
a third clock main line extending along the first direction;
a third clock branch line group including a plurality of clock branch lines extending along the second direction and electrically connected to the third clock main line;
a third clock driving cell electrically connected to the third clock main line for driving merely the third clock main line and the third clock branch line group; and
a third clock synchronous cell group including a plurality of clock synchronous cells electrically connected to the third clock main line or the third clock branch line group,
the first clock main line, the second clock main line and the third clock main line are arranged in this order along the second direction,
a distance between the first clock main line and the second clock main line and a distance between the second clock main line and the third clock main line are different from each other, and
the first clock branch line group, the second clock branch line group and the third clock branch line group are different from one another in length of the clock branch lines included therein.

11. The semiconductor integrated circuit of claim 1,
wherein the first clock main line and the second clock main line have different lengths.

12. The semiconductor integrated circuit of claim 1,
wherein the clock distribution circuit further includes:
a third clock main line extending along the first direction on a side of the second clock main line along a forward or reverse direction of the first direction;
a third clock branch line group including a plurality of clock branch lines extending along the second direction and electrically connected to the third clock main line;
a third clock driving cell electrically connected to the third clock main line for driving merely the third clock main line and the third clock branch line group; and
a third clock synchronous cell group including a plurality of clock synchronous cells electrically connected to the third clock main line or the third clock branch line group, and
the first clock main line has a length larger than a sum of lengths of the second clock main line and the third clock main line.

13. The semiconductor integrated circuit of claim 1,
wherein the clock distribution circuit further includes a hard macro placed at a center of the first clock main line or the second clock main line, and
the first clock driving cell and the second clock driving cell are placed so as not to overlap the hard macro and to be spaced from each other along the first direction.

14. The semiconductor integrated circuit of claim 1,
wherein the clock distribution circuit further includes a hard macro having a plurality of clock connection pins each for receiving a clock signal,
the semiconductor integrated circuit includes a plurality of interconnection layers having a large thickness in an upper layer and a small thickness in a lower layer, and
each clock connection pin is connected, by using an interconnection of the lower layer with a small thickness, to one line placed in a position at a shortest distance along a forward or reverse direction of the first direction out of the plurality of clock branch lines included in the first clock branch line group, the plurality of clock branch lines included in the second clock branch line group, or the first clock main line and the second clock main line.

15. The semiconductor integrated circuit of claim 1,
wherein the first clock driving cell and the second clock driving cell respectively have clock connection pins each for supplying a clock signal,
the clock connection pins are aligned straight, and
a portion from the clock source driver to the clock connection pins of the first clock driving cell and the second clock driving cell is constructed by using a buffer tree of a plurality of stages respectively having the same length.

16. The semiconductor integrated circuit of claim 15,
wherein the clock distribution circuit further includes:
a third clock main line extending along the first direction on a side of the first clock main line along a forward or reverse direction of the first direction;
a third clock branch line group including a plurality of clock branch lines extending along the second direction and electrically connected to the third clock main line;
a third clock driving cell electrically connected to the third clock main line for driving merely the third clock main line and the third clock branch line group;
a third clock synchronous cell group including a plurality of clock synchronous cells electrically connected to the third clock main line or the third clock branch line group;
a fourth clock main line extending along the first direction on a side of the second clock main line along a forward or reverse direction of the first direction;
a fourth clock branch line group including a plurality of clock branch lines extending along the second direction and electrically connected to the fourth clock main line;
a fourth clock driving cell electrically connected to the fourth clock main line for driving merely the fourth clock main line and the fourth clock branch line group; and
a fourth clock synchronous cell group including a plurality of clock synchronous cells electrically connected to the fourth clock main line or the fourth clock branch line group,
the third clock driving cell and the forth clock driving cell respectively have clock connection pins each for supplying a clock signal, and
a portion from the clock source driver to the clock connection pins of the third clock driving cell and the fourth clock driving cell is constructed by using another buffer tree of a plurality of stages respectively having the same length.

17. The semiconductor integrated circuit of claim 15,
wherein the clock distribution circuit further includes:
a third clock main line extending along the first direction on a side of the first clock main line along a forward or reverse direction of the first direction;
a third clock branch line group including a plurality of clock branch lines extending along the second direction and electrically connected to the third clock main line;
a third clock driving cell electrically connected to the third clock main line for driving merely the third clock main line and the third clock branch line group;
a third clock synchronous cell group including a plurality of clock synchronous cells electrically connected to the third clock main line or the third clock branch line group;
a fourth clock main line extending along the first direction on a side of the second clock main line along a forward or reverse direction of the first direction;
a fourth clock branch line group including a plurality of clock branch lines extending along the second direction and electrically connected to the fourth clock main line;
a fourth clock driving cell electrically connected to the fourth clock main line for driving merely the fourth clock main line and the fourth clock branch line group; and
a fourth clock synchronous cell group including a plurality of clock synchronous cells electrically connected to the fourth clock main line or the fourth clock branch line group,
the third clock driving cell and the fourth clock driving cell respectively have clock connection pins each for supplying a clock signal, and
the buffer tree is shared by a portion from the clock source driver to the clock connection pins of the third clock driving cell and the fourth clock driving cell.

18. The semiconductor integrated circuit of claim 1,
wherein the clock distribution circuit further includes:
a third clock main line extending along the first direction;
a third clock branch line group including a plurality of clock branch lines extending along the second direction and electrically connected to the third clock main line;
a third clock driving cell electrically connected to the third clock main line for driving merely the third clock main line and the third clock branch line group;
a third clock synchronous cell group including a plurality of clock synchronous cells electrically connected to the third clock main line or the third clock branch line group;
a fourth clock main line extending along the first direction;
a fourth clock branch line group including a plurality of clock branch lines extending along the second direction and electrically connected to the fourth clock main line;
a fourth clock driving cell electrically connected to the fourth clock main line for driving merely the fourth clock main line and the fourth clock branch line group;
a fourth clock synchronous cell group including a plurality of clock synchronous cells electrically connected to the fourth clock main line or the fourth clock branch line group; and
another clock source driver for providing a clock signal to the third clock driving cell and the fourth clock driving cell,
the first clock main line, the second clock main line, the third clock main line and the fourth clock main line are arranged in this order along the second direction, and
different clock signals are respectively input to the clock source driver for providing a clock signal to the first clock driving cell and the second clock driving cell and the clock source driver for providing a clock signal to the third clock driving cell and the fourth clock driving cell.

19. A layout method for a semiconductor integrated circuit including a clock distribution circuit for distributing a clock signal, comprising:
a region dividing step of dividing a functional block including the clock distribution circuit into a plurality of regions along a first direction;
a main line placement step of providing a clock main line at a center of each region to extend along the first direction by using an interconnection of an upper layer with a large thickness;
a branch line placement step of providing a plurality of clock branch lines to extend along a second direction perpendicular to the first direction with the clock main line set as a center;
a driving cell placement/connection step of providing a clock driving cell for driving the clock main line and the clock branch lines at the center of each region and forming a line for connecting the clock driving cell to the clock main line;
a clock connection step of forming a line for connecting each clock synchronous cell placed in each region to one of the clock main line and the clock branch lines placed nearby in the same region; and
a buffer tree building step of building a buffer tree extending from a clock source driver to the clock driving cell.
